(19) United States
(12) Patent Application Publication
(10) Pub. No.: US 2010/0123938 A1
(43) Pub. Date: May 20, 2010

(54) WEB PAGE DISPLAY CONTROLLER, METHOD FOR DISPLAYING WEB PAGE, AND COMPUTER-READABLE STORAGE MEDIUM FOR COMPUTER PROGRAM

(75) Inventor: Wataru Sunami, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/617,057

(22) Filed: Nov. 12, 2009

(30) Foreign Application Priority Data
Nov. 18, 2008 (JP) 2008-294504

(51) Int. Cl. G06K 15/00; G06F 3/01

(52) U.S. Cl. 358/1.18; 715/760

(57) ABSTRACT

An image forming apparatus (1) having a web browser function and a touch screen is provided with a history storage portion (1K1) that stores a state of a web page for a case in which the web page is displayed on the touch screen and a display control portion (103) that causes, when a web page is specified again as a target to be displayed on the touch screen, the touch screen to display the web page in the state of the web page that is stored in the history storage portion (1K1).

This application is based on Japanese patent application No. 2008-294504 filed on Nov. 18, 2008, the contents of which are hereby incorporated by reference.

### BACKGROUND OF THE INVENTION

1. Field of the Invention

The present invention relates to a device, a method, and the like for causing a display to display a web page.

2. Description of the Related Art

Image forming apparatuses called “multifunction devices”, “Multi-Function Peripherals (MFPs)”, or the like have recently come into widespread use in offices of business and homes. Such image forming apparatuses are configured to integrate, thereinto, a variety of functions, such as copying, network printing (PC printing), faxing, and scanning.

Such an image forming apparatus is generally provided with a display such as a touch screen to enhance the user interface thereof. Such a display is configured to produce a color display, have a high resolution, and produce a display of sharper images than before. The image forming apparatus is compatible with Transmission Control Protocol/Internet Protocol (TCP/IP), which enables the image forming apparatus to perform communication with other devices via the Internet. An image forming apparatus having a web browser function is proposed in Japanese Laid-open Patent Publication No. 2008-180894.

An image forming apparatus that includes a display and a web browser, and is compatible with TCP/IP enables a user to browse a web page publicized by a web server on the Internet. Such an image forming apparatus is also configured to print the web page onto paper.

The performance of a display included in an image forming apparatus has increased; however, the resolution thereof is often lower than that of a display included in a personal computer. One reason for this is that a user edits and browses an image quite often by using a personal computer rather than an image forming apparatus, and therefore, a high-resolution display tends to be provided in the personal computer rather than in the image forming apparatus. Another reason is that a space-saving image forming apparatus is generally preferred, and therefore, it is difficult to provide a large display in an image forming apparatus.

Web pages are usually created based on the assumption that a user uses a personal computer to browse the web pages. Accordingly, a web page is not fully displayed on a display more often in the case of using an image forming apparatus to browse the web page than in the case of using a personal computer to browse the web page. As a result, the user is forced to often scroll the display of the image forming apparatus or to perform another operation.

A method for reducing a burdensome task of scrolling through a web page in information equipment in which a low-resolution display is provided is proposed in Japanese Laid-open Patent Publication No. 2006-209538. According to the method, a page storing part to temporarily store a web page at the time of browsing the web page is provided in a portable terminal. When the same web page as that previously stored in the page storing part is browsed again, a control part compares the details of the web page browsed this time with the details of the web page previously stored. Then, the control part moves a display range in such a manner that the updated portion is displayed at a predetermined position on a display part, and displays the web page browsed this time on the display part accordingly.

Incidentally, in some cases, a web page is very seldom updated after it has been publicized on a web server. The method described in Japanese Laid-open Patent Publication No. 2006-209538 is not so effective in the case of browsing a web page with a low update frequency.

### SUMMARY

The present disclosure is directed to solve the problems pointed out above, and therefore, an object of an embodiment of the present invention is to improve the user-friendliness for a case in which a user uses a low-resolution display to browse a web page.

A web page display controller according to one aspect of the present invention is a web page display controller for causing a display to display a web page in a state that is set in accordance with an operation performed by a user. The web page display controller includes a display state storage portion that stores the state of the web page, and a web page redisplay controller that causes, when the web page is specified again as a target to be displayed on the display, the display to display the web page in the state of the web page that is stored in the display state storage portion.

These and other characteristics and objects of the present invention will become more apparent by the following descriptions of preferred embodiments with reference to drawings.

### BRIEF DESCRIPTION OF THE DRAWINGS

FIG. 1 is a diagram illustrating an example of a network system including an image forming apparatus.

FIG. 2 is a diagram illustrating an example of the hardware configuration of an image forming apparatus.

FIG. 3 is a diagram illustrating an example of the functional configuration of an image forming apparatus.

FIG. 4 is a diagram illustrating an example of a browser window.

FIG. 5 is a diagram illustrating an example of a display conditions setting screen.

FIG. 6 is a diagram illustrating an example of a display history table.

FIG. 7 is a diagram illustrating an example of a browser window.

FIG. 8 is a flowchart illustrating an example of the flow of a display process for a case in which a web page is accessed again.

FIG. 9 is a diagram illustrating an example of a printing conditions setting screen.

FIG. 10 is a diagram illustrating an example of a printing history table.

FIG. 11 is a diagram illustrating an example of a printed material printed in a thumbnail print mode.

FIG. 12 is a diagram illustrating an example of a printed material printed in a plural parts print mode.

FIG. 13 is a flowchart illustrating an example of the overall processing flow of an image forming apparatus.

FIG. 14 is a flowchart illustrating an example of the overall processing flow of an image forming apparatus.

FIG. 15 is a flowchart illustrating an example of the flow of a display change process.

### DESCRIPTION OF THE PREFERRED EMBODIMENTS

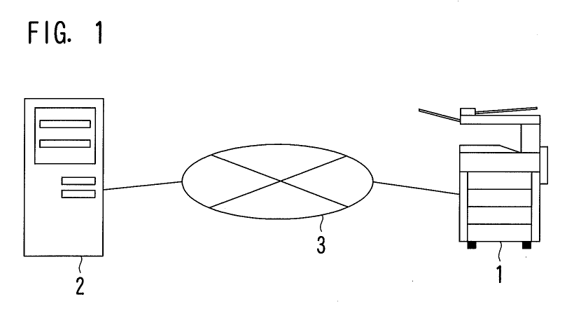

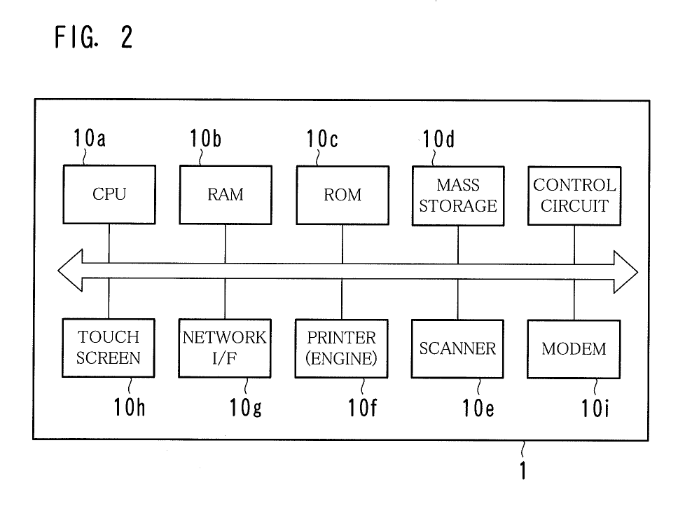

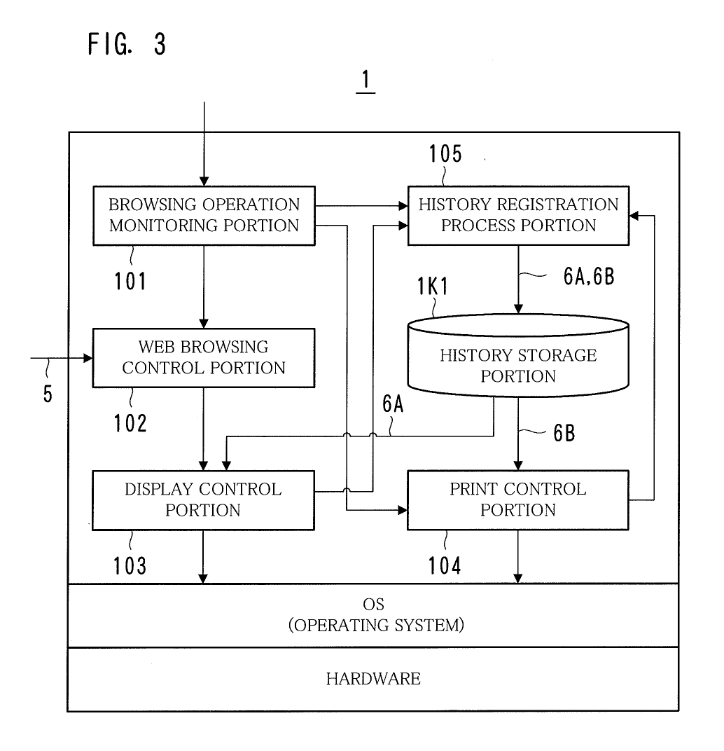

FIG. 1 is a diagram illustrating an example of a network system including an image forming apparatus 1; FIG. 2 is a diagram illustrating an example of the hardware configuration of the image forming apparatus 1; and FIG. 3 is a diagram illustrating an example of the functional configuration of the image forming apparatus 1.

The image forming apparatus 1 illustrated in FIG. 1 is an apparatus generally called a multifunction device, a Multi-Function Peripheral (MFP), or the like. The image forming apparatus 1 is configured to integrate, thereinto, a variety of functions, such as copying, network printing (PC printing), faxing, and scanning. Further, the image forming apparatus 1 has a web browser function, which enables the image forming apparatus 1 to download a web page from a web server 2 via a communication line 3, e.g., the Internet, and to display the web page thus downloaded.

Referring to FIG. 2, the image forming apparatus 1 is configured of a Central Processing Unit (CPU) 10a, a Random Access Memory (RAM) 10b, a Read-Only Memory (ROM) 10c, a mass storage 10d, a scanner 10e, a printer 10f, a network interface 10g, a touch screen 10h, a modem 10i, a control circuit, and so on.

The scanner 10e is a device that optically reads images printed on paper, such as photographs, characters, drawings, diagrams, and the like, and creates image data thereof.

The printer 10f serves to print, onto paper, the image obtained by scanning with the scanner 10e, or print, onto paper, a web page downloaded from the web server 2.

The touch screen 10h displays, for example, a screen for giving a message or instructions to a user, a screen for the user to enter details of setting and processes to be performed, and a web page. The touch screen 10h also detects a position thereof touched by the user with his/her finger and sends a signal indicating a result of the detection to the CPU 10a.

The network interface 10g is a Network Interface Card (NIC) for communicating with the web server 2 via the communication line 3.

The modem 10i is a device for transmitting image data via a fixed-line telephone network to a different facsimile terminal and vice versa based on a protocol such as G3.

The ROM 10c or the mass storage 10d stores an operating system and programs for implementing a web browser function, for example, functions of a browsing operation monitoring portion 101, a web browsing control portion 102, a display control portion 103, a print control portion 104, a history registration process portion 105, and a history storage portion 1K1, all of which are illustrated in FIG. 3. An example of the mass storage 10d is a hard disk or a flash memory. These programs are loaded into the RAM 10b as necessary, whereupon the programs are executed by the CPU 10a.

A detailed description will be given of processes performed by the individual portions of the image forming apparatus 1 illustrated in FIG. 3. The browsing operation monitoring portion 101 monitors an operation of the touch screen 10h performed by a user. The history storage portion 1K1 includes a display history table TBL1 and a printing history table TBL2, and serves to store a display history of web pages and a printing history thereof. The web browsing control portion 102, the display control portion 103, the print control portion 104, and the history registration process portion 105 perform the following processes based on operations performed by the user.

### [Case of Displaying a Web Page Accessed for the First Time]

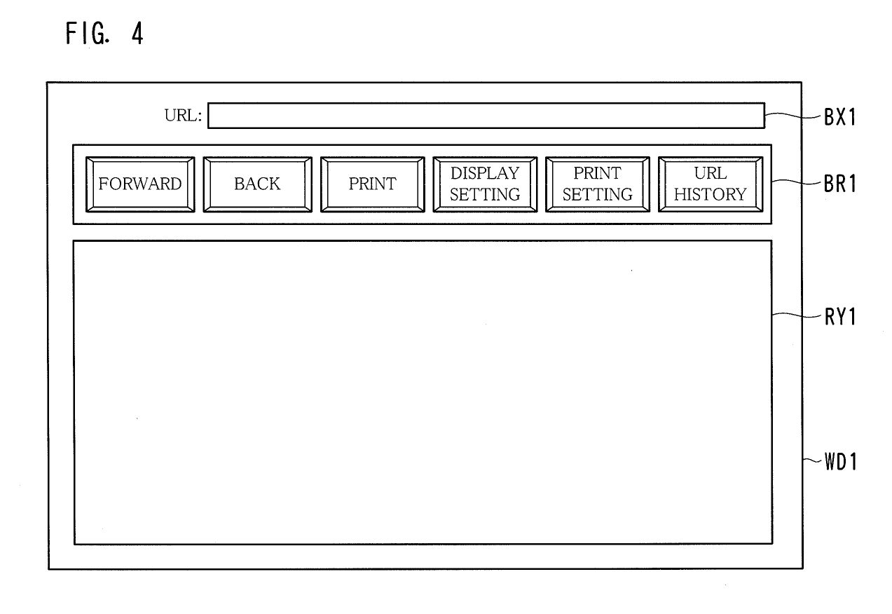

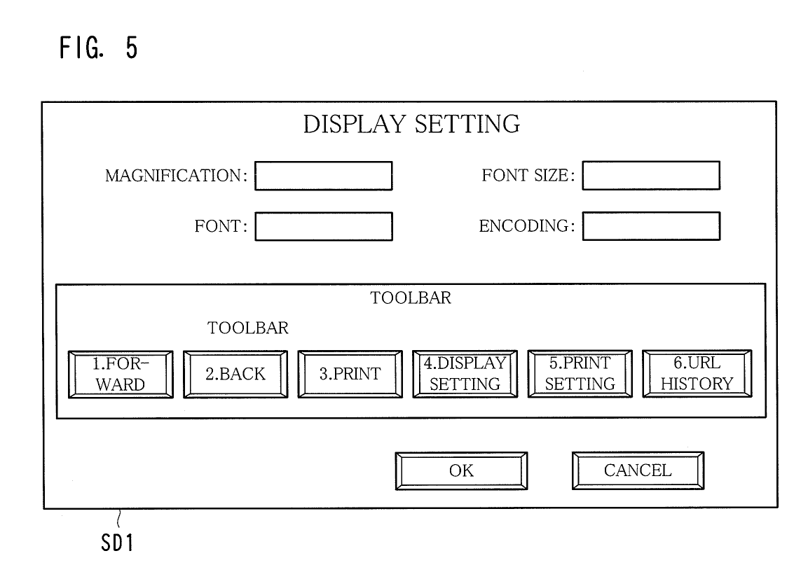

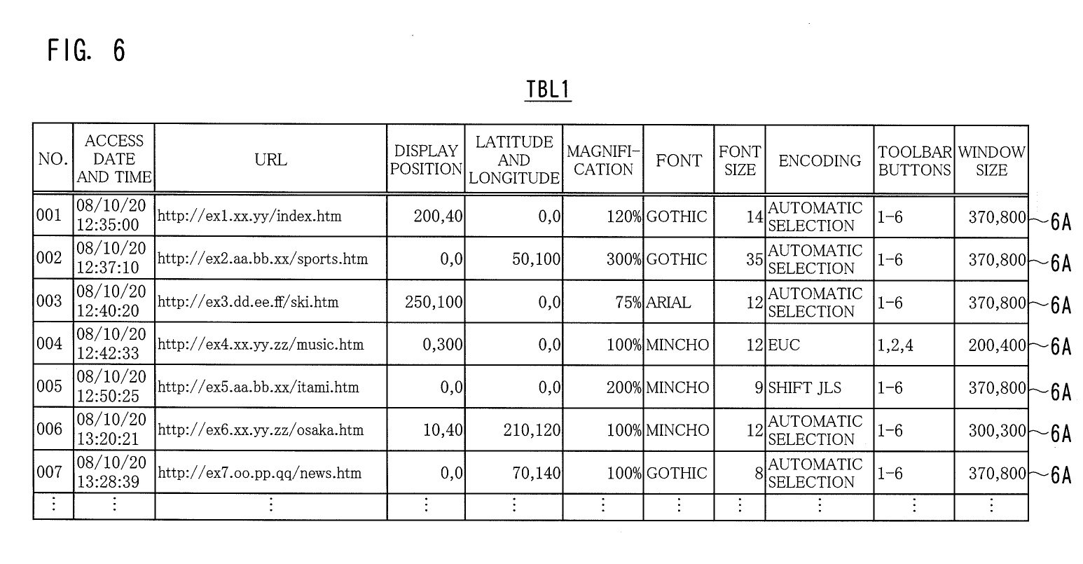

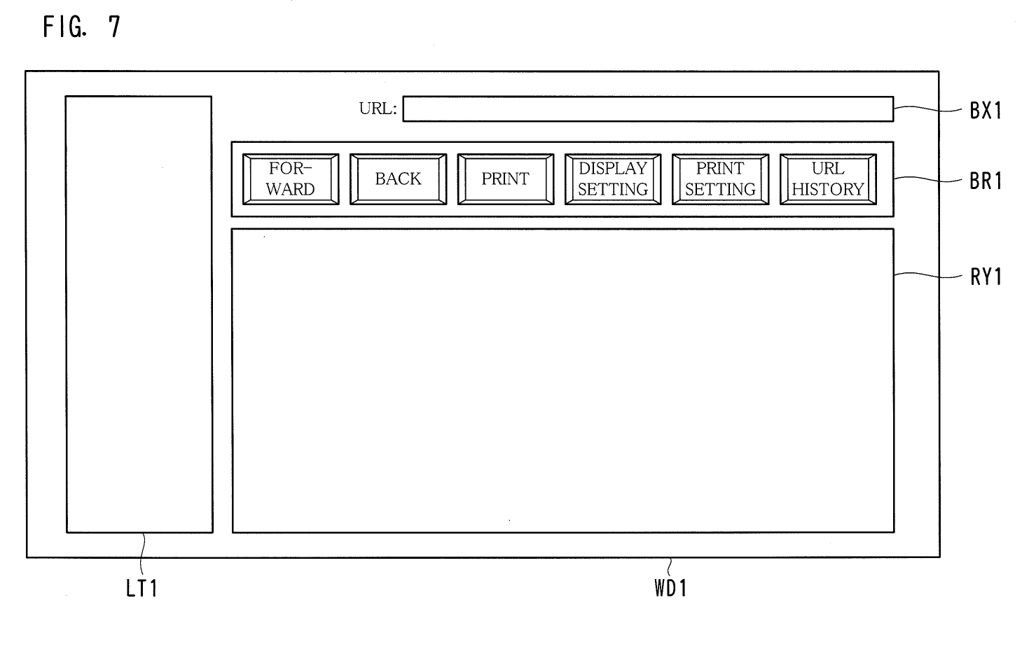

FIG. 4 is a diagram illustrating an example of a browser window WD1; FIG. 5 is a diagram illustrating an example of a display conditions setting screen SD1; FIG. 6 is a diagram illustrating an example of a display history table TBL1; and FIG. 7 is a diagram illustrating an example of the browser window WD1.

In the case where a user performs an operation for entering a Uniform Resource Locator (URL) or selecting a hyperlink on the browser window WD1 (see FIG. 4 or FIG. 7) which is described later, the web browsing control portion 102 downloads, from the web server 2, data for reproducing a web page based on the URL thus entered on the browser window WD1 or a URL associated with the hyperlink thus selected thereon. Such a URL is hereinafter referred to as simply a “specified URL”, or the like, and such data is hereinafter referred to as “web page data 5”. In short, the web browsing control portion 102 performs control for browsing the web page.

The display control portion 103 causes the touch screen 10h to display a variety of screens in accordance with operations performed by the user.

In the case where the user performs an operation for starting a browser, the display control portion 103 causes the touch screen 10h to display the browser window WD1 as illustrated in FIG. 4. The browser window WD1 includes a browser area RY1, a text box BX1, and a toolbar BR1.

The browser area RY1 is an area to display a web page. The display control portion 103 constructs a web page again based on web page data 5 downloaded by the web browsing control portion 102, and causes the touch screen 10h to display the web page thus constructed in the browser area RY1.

The text box BX1 is a text box for the user to enter a URL. The toolbar BR1 contains six buttons through each of which the user can issue a command to the image forming apparatus 1 or can set conditions for a process.

The user performs an operation similar to an operation performed on a conventional window; and thereby the user can change the size of the browser area RY1 or scroll through a web page displayed in the browser area RY1 vertically or horizontally.

A web page sometimes contains a scrollable object, e.g., a so-called scroll map. In such a case, the user performs an operation in such a manner that the scrollable object is displayed in the browser area RY1. Then, the user can scroll through the scrollable object and browse desired information.

If a “back” button is pressed, then the display control portion 103 stops displaying a current web page that is currently displayed in the browser area RY1, and displays again, in the browser area RY1, a previous web page that was displayed immediately before a URL of the current web page was specified. Subsequently, if a “forward” button is pressed, then the display control portion 103 displays again, in the browser area RY1, the current web page that was displayed immediately before the “back” button was pressed.

If a “display setting” button is pressed, then the display control portion 103 displays the display conditions setting screen SD1 as illustrated in FIG. 5 on the browser window WD1. The user can set, on the display conditions setting screen SD1, a display magnification of the current web page, a font to be used as letters contained in the current web page, a size of the font, and a type of encoding. The user can also set which button contained in the toolbar BR1 should be arranged on the browser window WD1 and which button should not be arranged (should be hidden) thereon.

If an “OK” button is pressed on the display conditions setting screen SD1, then the display control portion 103 closes the display conditions setting screen SD1, constructs again the current web page based on the individual conditions set on the display conditions setting screen SD1, and displays the web page thus constructed again in the browser area RY1.

Every time a web page is displayed, the history registration process portion 105 generates display state data 6A as illustrated in FIG. 6 and stores the display state data 6A in the display history table TBL1. The display state data 6A indicates in what way the web page is displayed, in what way the browser window WD1 is displayed, and identification information about the web page, e.g., a URL of the web page.

Referring to the display state data 6A, the field named “access date and time” indicates a date and time at which the image forming apparatus 1 accesses the web server 2 to download the web page therefrom and display the web page thus downloaded.

The field named “URL” indicates a URL of the web page. The field named “display position” indicates information about a part of the web page displayed in the browser area RY1. In this example, the top left coordinates of the part are indicated in the “display position” field. The field named “latitude and longitude” indicates coordinates (latitude and longitude) of the center of a currently displayed part of an object such as a scroll map contained in the web page.

The fields named “magnification”, “font”, “font size”, and “encoding”, respectively, indicate a display magnification, a font to be used as letters, a size of the font, and a type of encoding, all of which are entered on the display conditions setting screen SD1. The field named “toolbar buttons” indicates codes of the individual buttons that are selected on the display conditions setting screen SD1 and are to be contained in the toolbar BR1.

The field named “window size” indicates the size of the browser area RY1, i.e., the vertical and horizontal lengths thereof.

In the case where any of those items mentioned above are modified in response to an operation performed by the user, the history registration process portion 105 updates the display state data 6A generated thereby accordingly. When, for example, the user scrolls (moves) through the web page, the history registration process portion 105 updates the values indicated in the “display position” field of the display state data 6A in accordance with the vertical movement amount and the horizontal movement amount. When the size of the browser area RY1 is modified, the history registration process portion 105 updates the values indicated in the “window size” field in such a manner that the size thus modified is indicated therein.

Note that default values are predetermined in the individual fields of the display state data 6A. Such a default value is used in a field in which no value is determined even after the user has performed the foregoing operation.

Further, as described later, new display state data 6A is generated also when the image forming apparatus 1 accesses the same web page as that previously accessed and the web page is displayed again. As a result, a plurality of pieces of the display state data 6A corresponding to the identical web page may be stored in the display history table TBL1.

Referring back to FIG. 4, if a “URL history” button is pressed, then the display control portion 103 reduces, as illustrated in FIG. 7, the browser area RY1, the toolbar BR1, and the text box BX1, and places a URL history list LT1. After that, the display control portion 103 displays the browser window WD1 again. The URL history list LT1 indicates a list of URLs included in the individual pieces of the display state data 6A that are stored in the display history table TBL1, namely, a history of web pages displayed in the past. Note that a history of the web pages is displayed in a manner to avoid the repetition of the same URL.

Character strings of the individual URLs included in the URL history list LT1 are hyperlinks. This enables the user to browse once again web pages that were browsed in the past only by clicking on the corresponding URLs. In the case where a web page is displayed again, display state data 6A for the web page is referred to, which will be described later.

If the “URL history” button is pressed once again, then the display control portion 103 closes the URL history list LT1 and displays again the browser window WD1 as illustrated in FIG. 4. The details of processes performed by the display control portion 103 for a case in which a “print setting” button is pressed are given later.

### [Case of Displaying a Web Page Accessed Again]

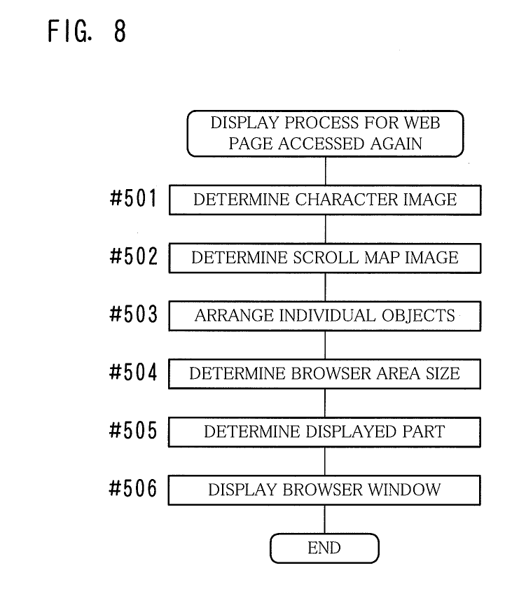

FIG. 8 is a flowchart illustrating an example of the flow of a display process for a case in which a web page is accessed again.

In the case where the image forming apparatus 1 accesses again a web page that was previously accessed and displayed and such a web page is displayed again, the display control portion 103 causes the touch screen 10h to display the web page in accordance with the details indicated in the latest display state data 6A for the web page, i.e., the display state data 6A generated when the web page was accessed the last time. To be specific, the display control portion 103 performs the process in the manner illustrated in FIG. 8.

The display control portion 103 calls the latest display state data 6A for the web page from the display history table TBL1. Then, in accordance with the latest display state data 6A, the display control portion 103 determines characters contained in the web page by using a font that is indicated in the “font” field and a size indicated in the “font size” field and by reconstructing the characters based on the type of encoding indicated in the “encoding” field (#501 in FIG. 8). If the web page contains a scrollable object such as a scroll map, then the display control portion 103 determines an image of the scrollable object based on coordinates indicated in the “latitude and longitude” field (#502). The display control portion 103 places the characters and the image of the scrollable object that are determined as mentioned above, places other kinds of images based on a source code, and thereby generates data of the entire image of the web page, e.g., bitmap data (#503).

In parallel with the process for determining the entire image or before or after the same, the display control portion 103 determines a size indicated in the “window size” field as the size of the browser area RY1 (#504).

The display control portion 103 specifies a part of the web page falling within the browser area RY1 for a case in which the web page is scrolled down and scrolled to the right by an amount indicated in the “display position” field from the state in which the upper left corner of the entire image of the web page is aligned to the upper left corner of the browser area RY1 having the size indicated in the “window size” field, and further the web page is enlarged to or reduced to a magnification indicated in the “magnification” field (#505).

Subsequently, the display control portion 103 causes the touch screen 10h to display the browser window WD1 on which the browser area RY1 showing an image of the specified part of the web page, the toolbar BR1, and the text box BX1 are placed (#506).

The history registration process portion 105 generates display state data 6A corresponding to a display of the web page this time and stores the display state data 6A in the display history table TBL1. The details of the processes carried out by the display control portion 103 and the history registration process portion 105 based on operations performed by a user are the same as those for the case in which the web page is displayed for the first time.

### [Process for Printing a Web Page]

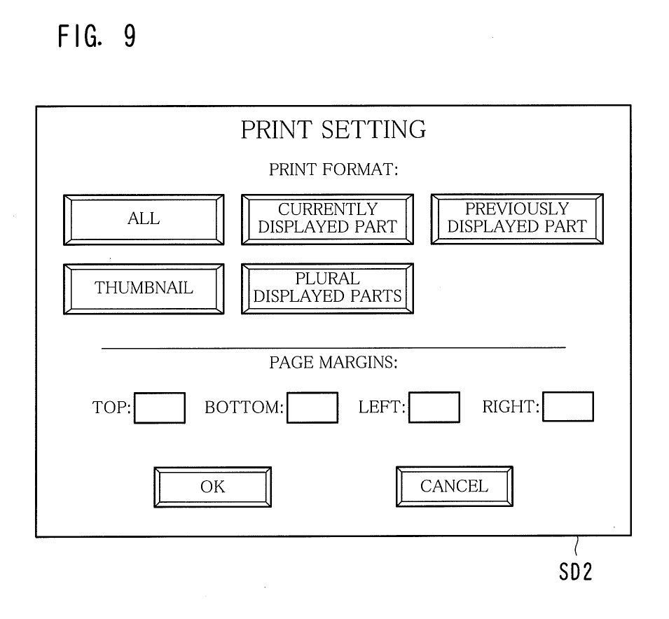

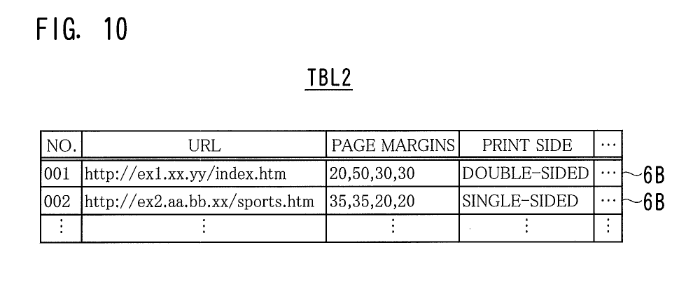

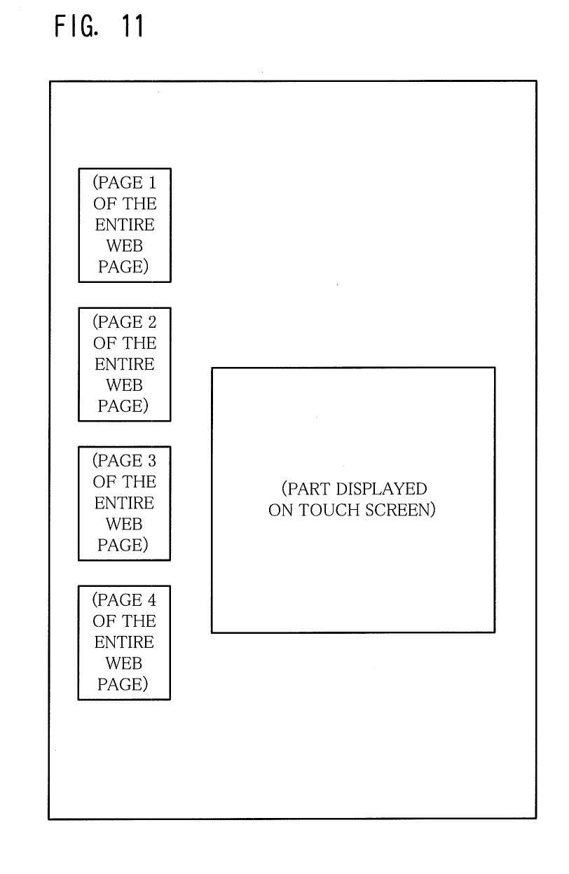

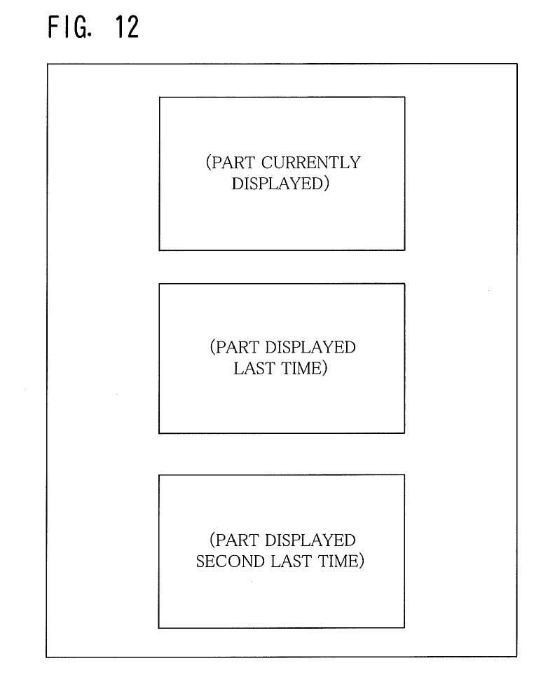

FIG. 9 is a diagram illustrating an example of a printing conditions setting screen SD2; FIG. 10 is a diagram illustrating an example of the printing history table TBL2; FIG. 11 is a diagram illustrating an example of a printed material printed in a thumbnail print mode; and FIG. 12 is a diagram illustrating an example of a printed material printed in a plural parts print mode.

If the “print setting” button is pressed on the browser window WD1, then the display control portion 103 displays the printing conditions setting screen SD2 as illustrated in FIG. 9 on the browser window WD1. The user can specify, on the printing conditions setting screen SD2, in what way the current web page is to be printed onto paper or how many page margins are to be set for the paper.

Responding to an “OK” button pressed on the printing conditions setting screen SD2, the display control portion 103 closes the printing conditions setting screen SD2. If a “print” button is pressed on the browser window WD1, then the print control portion 104 controls, for example, the printer 10f in the following manner such that a web page currently displayed is printed onto paper based on the details set on the printing conditions setting screen SD2.

Responding to an “all” button pressed on the printing conditions setting screen SD2, the print control portion 104 controls, for example, the printer 10f to print, onto paper, the entire image of a web page that is the current display target.

If the entire image of the web page is larger than the size of a sheet of paper, the image is printed onto a plurality of sheets of paper with the image divided. At this time, printing is so performed that page margins having the values entered in the individual text boxes of “top”, “bottom”, “left”, and “right” on the printing conditions setting screen SD2 are set for the individual sheets of paper. Further, in the case where conditions such as single-sided/double-sided printing or monochrome/color printing can be specified, printing is performed based on such conditions. After performing the printing, the history registration process portion 105 newly generates printing condition data 6B illustrated in FIG. 10 and indicating conditions such as page margins and a URL of the web page, and stores the printing condition data 6B thus generated in the printing history table TBL2. If printing condition data 6B for the web page is already stored in the printing history table TBL2, then the history registration process portion 105 deletes the printing condition data 6B already stored in the printing history table TBL2, and stores the printing condition data 6B newly generated therein. The same applies to four other print formats discussed below.

First, if a “currently displayed part” button is pressed, then the print control portion 104 controls, for example, the printer 10f to print, among a web page that is the current display target, a part currently displayed in the browser area RY1.

Second, if a “previously displayed part” button is pressed, then the print control portion 104 controls, for example, the printer 10f to print a web page that is the current display target by using the latest display state of the web page for a case in which the same web page was previously displayed in the browser area RY1. In such a case, the latest display state data 6A for the web page stored in the display history table TBL1 is referred to. To be specific, the print control portion 104 specifies a part of the web page satisfying conditions indicated in the latest display state data 6A and performs control such that the part thus specified is printed. The method for specifying the part is described earlier with reference to Step #501 through Step #506 in FIG. 8.

In the case where the web page was previously printed, page margins in the previous printing may be used as page margins in the printing this time. To be specific, page margins indicated in the printing condition data 6B for the web page stored in the printing history table TBL2 may be used as page margins in the printing this time.

Third, if a “thumbnail” button is pressed, then the print control portion 104 controls, for example, the printer 10f to print, onto one or more sheets of paper, among a web page that is the current display target, a part displayed in the browser area RY1 of the browser window WD1 and a reduced image, namely a thumbnail, of the entire web page.

Fourth, if a “plural displayed parts” button is pressed, then the print control portion 104 controls, for example, the printer 10f to print, onto one or more sheets of paper, among a web page that is the current display target, a part displayed in the browser area RY1 of the browser window WD1 and parts of the web page that were previously displayed therein. The parts previously displayed are indicated in the individual pieces of the display state data 6A for the web page stored in the display history table TBL1. The method for specifying the parts previously displayed based on the display state data 6A was described earlier with reference to Step #501 through Step #506 in FIG. 8.

If a user presses the “print” button on the browser window WD1 without specifying a print format or page margins on the printing conditions setting screen SD2, then the print control portion 104 may perform a process in such a manner that the web page is printed based on a format or page margins indicated in the printing condition data 6B for the web page, i.e., a format or page margins used for a case in which the web page was previously printed.

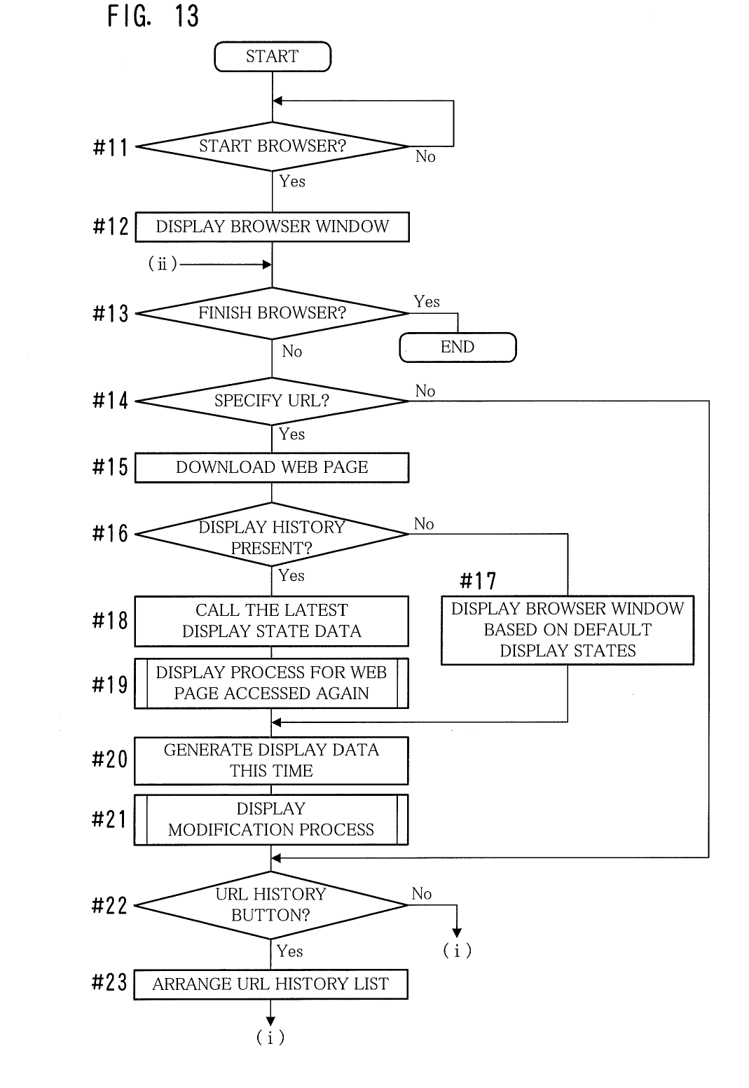

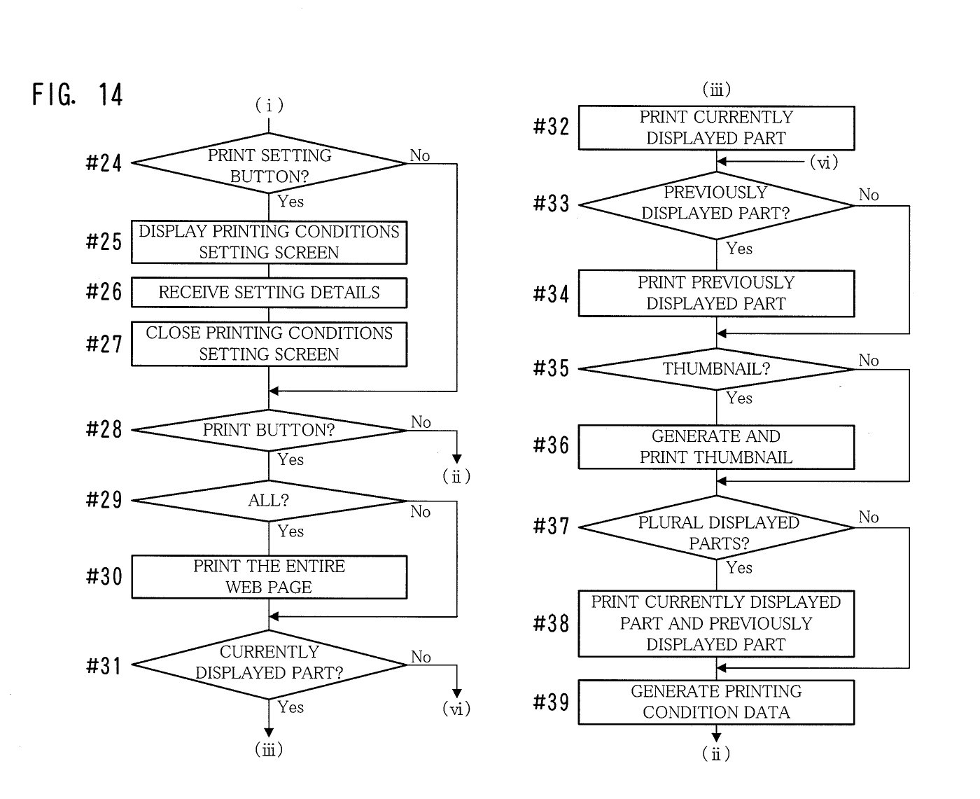

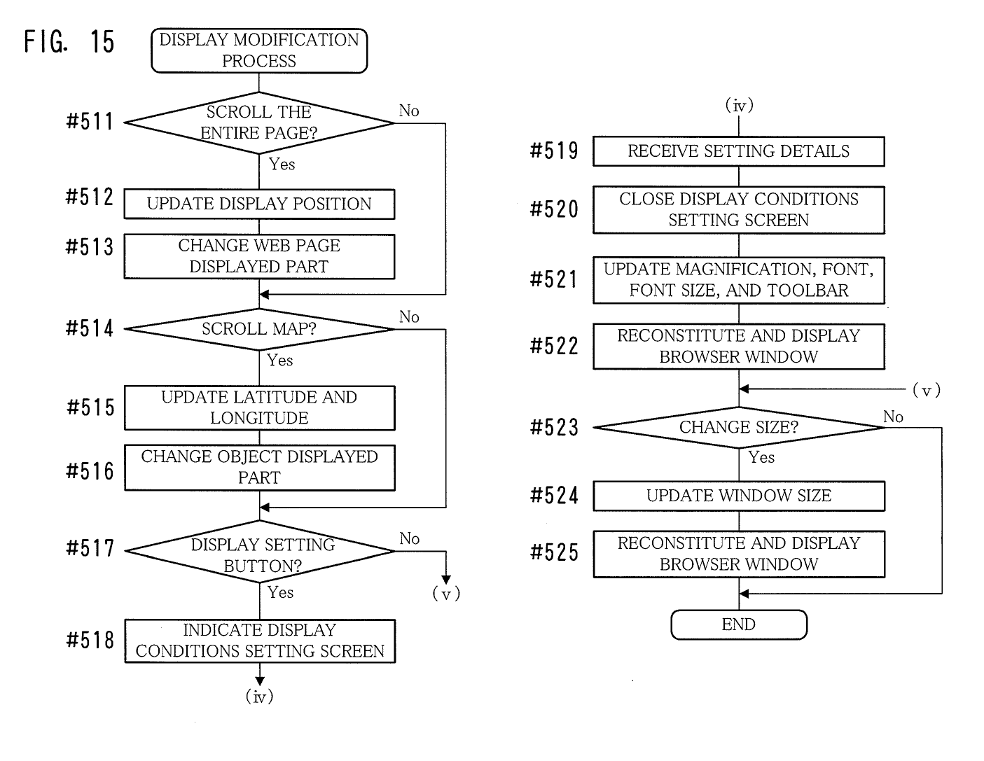

FIGS. 13 and 14 are flowcharts illustrating an example of the overall processing flow of the image forming apparatus 1, and FIG. 15 is a flowchart illustrating an example of the flow of a display change process.

The following is a description of the overall processing flow of the image forming apparatus 1 for a case in which a web browser function is used, with reference to the flowcharts.

Referring to FIGS. 13 and 14, when a user enters a command to start a web browser (Yes in #11), the image forming apparatus 1 starts the web browser and displays the browser window WD1 as illustrated in FIG. 4 (#12).

Every time the user performs an operation, the image forming apparatus 1 carries out the following process in accordance with the operation until the image forming apparatus 1 finishes the web browsing service.

When the user specifies a URL (Yes in #14), the image forming apparatus 1 downloads a web page indicated in the URL from the web server 2 (#15).

If the display history table TBL1 (see FIG. 6) does not store therein display state data 6A for the web page, i.e., if the image forming apparatus 1 accesses the web page for the first time (No in #16), then the image forming apparatus 1 displays the web page in the browser area RY1 based on default conditions (#17).

If the display history table TBL1 stores therein display state data 6A for the web page (Yes in #16), then the image forming apparatus 1 calls (#18) the latest display state data 6A, i.e., the display state data 6A for a case in which the web page was previously displayed, and displays (#19) the web page in accordance with the details indicated in the display state data 6A. Detailed steps for displaying the web page were given earlier with reference to FIG. 8.

Then, the image forming apparatus 1 newly generates display state data 6A corresponding to a display of the web page this time and stores the display state data 6A in the display history table TBL1 (#20).

While the web page is displayed, the image forming apparatus 1 modifies a display state of the web page in accordance with an operation performed by a user. For example, a font, a magnification, an arrangement of buttons in the toolbar, a part of the web page displayed in the browser area RY1, and the size of the browser area RY1 are modified. Then, the image forming apparatus 1 updates the display state data 6A corresponding to the display of the web page this time in accordance with the modification (#21). The processes for modifying a display state of the web page and updating the display state data 6A are performed in the manner illustrated in FIG. 15.

Referring to FIG. 15, when the user performs a scroll operation (Yes in #511), the image forming apparatus 1 updates the value in the “display position” field of the display state data 6A in accordance with the scroll operation (#512) and scrolls through the web page (#513).

Further, when the user performs a scroll operation on a scrollable object such as a scroll map (Yes in #514), the image forming apparatus 1 updates the value in the “latitude and longitude” field of the display state data 6A in accordance with the scroll operation (#515) and scrolls through the scrollable object (#516).

If the user presses the “display setting” button (Yes in #517), then the image forming apparatus 1 displays the display conditions setting screen SD1 as illustrated in FIG. 5 (#518) and receives the details of display setting (#519). Subsequently, the image forming apparatus 1 closes the display conditions setting screen SD1 (#520) and updates the individual values in the fields of “magnification”, “font size”, “font”, “encoding”, and “toolbar buttons” of the display state data 6A in accordance with the details of display setting that have been received (#521). Along with this, the image forming apparatus 1 modifies, for example, the magnification, the font, and the font size of the web page, and the arrangement of the buttons contained in the toolbar BR1, and displays again the browser window WD1 (#522).

If the user performs an operation for modifying the size of the browser area RY1 (Yes in #523), then the image forming apparatus 1 updates the value in the “window size” field of the display state data 6A accordingly (#524), modifies the size of the browser area RY1, and displays again the browser window WD1 (#525).

Referring back to FIGS. 13 and 14, if the user presses the “URL history” button (Yes in #22), then the image forming apparatus 1 displays again the browser window WD1 with the URL history list LT1 situated as illustrated in FIG. 7 (#23).

If the user presses the “print setting” button (Yes in #24 of FIG. 14), then the image forming apparatus 1 displays the printing conditions setting screen SD2 as illustrated in FIG. 9 (#25). The user specifies the print format of the web page and page margins. The image forming apparatus 1 receives the details specified by the user (#26) and closes the printing conditions setting screen SD2 (#27).

Subsequently, when the user presses the “print” button (Yes in #28), the image forming apparatus 1 prints the web page currently displayed based on the specified details received in Step #26 in the following manner.

If the “all” is specified on the printing conditions setting screen SD2 (Yes in #29), then the image forming apparatus 1 prints the entire web page (#30).

If the “currently displayed part” is specified (Yes in #31), then the image forming apparatus 1 prints, among the web page, a part that is currently displayed in the browser area RY1 (#32).

If the “previously displayed part” is specified (Yes in #33), then the image forming apparatus 1 prints, among the web page, a part that is specified based on the latest display state data 6A for the web page (#34). At this time, the printing may be performed in such a manner that page margins are set as indicated in the printing condition data 6B for a case in which the web page was previously printed.

If the “thumbnail” is specified (Yes in #35), then the image forming apparatus 1 prints, onto one or more sheets of paper, thumbnails of the web page and a part of the web page that is currently displayed in the browser area RY1, as illustrated in FIG. 11 (#36).

If the “plural displayed parts” is specified (Yes in #37), then the image forming apparatus 1 prints, onto one or more sheets of paper, among the web page, a part that is currently displayed in the browser area RY1 and a part that was previously displayed therein (#38).

Then, the image forming apparatus 1 generates printing condition data 6B indicating the printing conditions this time and stores the printing condition data 6B in the printing history table TBL2 (#39).

According to this embodiment, it is possible to improve the user-friendliness for a case in which a user browses a web page with the image forming apparatus 1 including a display having a resolution lower than that of a display of a personal computer.

This embodiment describes a case where the image forming apparatus 1 such as an MFP is used to display a web page. The present invention, however, is applicable to other information devices with a low-resolution display. The present invention is applicable, for example, to a mobile phone terminal, a Personal Digital Assistant (PDA), or a small laptop computer.

In this embodiment, the display state data 6A and the printing condition data 6B are recorded and used without distinguishing between individual users using the image forming apparatus 1. Instead, however, the display state data 6A and the printing condition data 6B may be recorded and used selectively on a user-by-user basis.

In the embodiments discussed above, the overall configuration of the image forming apparatus 1, the configurations of various portions thereof, the content to be processed, the processing order, the structure of the tables and the like may be altered as required in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A web page display controller for causing a display to display a web page in a state that is set in accordance with an operation performed by a user, the web page display controller comprising:
a display state storage portion that stores the state of the web page; and
a web page redisplay controller that causes, when the web page is specified again as a target to be displayed on the display, the display to display the web page in the state of the web page that is stored in the display state storage portion.

2. The web page display controller according to claim 1,
wherein if the display state storage portion stores a plurality of the states of the web page, the web page redisplay controller causes the display to display the web page in a latest state among the plurality of the states.

3. The web page display controller according to claim 1, wherein the display state storage portion stores, as the state of the web page, a state of a previously-displayed part of the web page, the previously-displayed part being a part previously displayed in a predetermined display area of a screen of the display.

4. The web page display controller according to claim 3, further comprising a print controller that controls a printer to print, onto paper, the previously-displayed part of the web page based on the state of the web page that is stored in the display state storage portion.

5. The web page display controller according to claim 3, further comprising a print controller that controls a printer to print a currently-displayed part of the web page and the previously-displayed part of the web page side-by-side onto paper, the currently-displayed part being a part to be currently displayed in the predetermined display area.

6. The web page display controller according to claim 3, further comprising a print controller that controls a printer to print a currently-displayed part of the web page and thumbnails of individual pages constituting the web page side-by-side onto paper, the currently-displayed part being a part to be currently displayed in the predetermined display area.

7. The web page display controller according to claim 4, further comprising a page margins storage portion that stores page margins set for paper for a case in which the printer prints a part or a whole of the web page,
wherein when the printer prints again the part or the whole of the web page, the print controller controls the printer in such a manner that the web page is printed with the page margins stored in the page margins storage portion.

8. The web page display controller according to claim 1, wherein the display state storage portion stores, as the state of the web page, a state of an object contained in the web page.

9. The web page display controller according to claim 8,
wherein the object is a character object, and
the display state storage portion stores, as the state of the web page, a state of at least one of a size of the object and a font of the object.

10. The web page display controller according to claim 8,
wherein the object is a map image object, and
the display state storage portion stores, as the state of the web page, a state of a display range of the object.

11. The web page display controller according to claim 1, wherein the display state storage portion stores, as the state of the web page, a state of a display magnification of the web page.

12. The web page display controller according to claim 1, wherein the display state storage portion stores, as the state of the web page, a state of a size of an area in which the web page is placed.

13. The web page display controller according to claim 1, wherein the display state storage portion stores, as the state of the web page, a display state of buttons by way of which individual commands are entered to perform a process on the web page.

14. A method for causing a display to display a web page in a state that is set in accordance with an operation performed by a user, the method comprising:
causing a computer controlling the display to perform:
controlling a display state storage portion to store the state of the web page, and
controlling, when the web page is specified again as a target to be displayed on the display, the display to display the web page in the state of the web page that is stored in the display state storage portion.

15. A computer-readable storage medium storing thereon a computer program used in a computer that controls a display to display a web page in a state that is set in accordance with an operation performed by a user, the computer program causing the computer to perform:
controlling a display state storage portion to store the state of the web page, and
controlling, when the web page is specified again as a target to be displayed on the display, the display to display the web page in the state of the web page that is stored in the display state storage portion.
